(19) United States
(12) Patent Application Publication
(10) Pub. No.: US 2007/0252887 A1
(43) Pub. Date: Nov. 1, 2007

(54) Printing Method for a Thermal Transfer Receiving Sheet Technical Field

(75) Inventors: Yoshio Mizuhara, Tokyo (JP); Yoshimasa Tanaka, Tokyo (JP); Kazuyuki Tachibana, Tokyo (JP); Yoshihiro Shimizu, Tokyo (JP); Hideaki Shinohara, Tokyo (JP)

Correspondence Address: KRATZ, QUINTOS & HANSON, LLP, 1420 K Street, N.W., Suite 400, WASHINGTON, DC, 20005, US

(73) Assignee: OJI PAPER CO., LTD., TOKYO (JP)

(21) Appl. No.: 11/628,674

(22) PCT Filed: Jun. 14, 2005
(86) PCT No.: PCT/JP05/11208

§ 371 Date: Dec. 6, 2006

(30) Foreign Application Priority Data
Jun. 16, 2004 (JP) 2004--178839
Aug. 4, 2004 (JP) 2004-228451
May 6, 2005 (JP) 2005--135312

(51) Int. Cl. B41J 2/325; B41J 2/315

(52) U.S. Cl. 347/212

(57) ABSTRACT

A printing method for a thermal transfer receiving sheet in which an image is formed on an image transfer layer of the receiving sheet by superimposing the sheet onto a dye thermal transfer sheet and applying thereto heat from a thermal head of a thermal transfer printer; wherein, the thermal transfer printer has a thermal head and a platen roller in opposition thereto, and the following requirements (1) and (2) are satisfied simultaneously: (1) the ratio (L/R) of the length of the entire thermal transfer receiving sheet (L) to the radius (R) of the platen roller of the printer is 0.01 to 0.07; and, (2) after a thermal transfer image has been formed on the image receiving layer by the thermal head, the thermal transfer receiving sheet is transported by the back side thereof being wound onto the surface of the platen roller, and the winding angle is 2 to 25°.

### TECHNICAL FIELD

The present invention relates to a method for printing a thermal transfer receiving sheet, wherein images can be obtained by superimposing the sheet on a dye thermal transfer sheet and thermal-transferring the dye by means of a thermal head as a device. More particularly, the present invention relates to a method for printing a thermal transfer receiving sheet (to be simply referred to as a “receiving sheet”) used in a thermal transfer system which uses a sublimation dye as the dye and enabling high-density recorded images to be formed in full color.

### BACKGROUND ART

Increasing attention has been focused on thermal printers, and particularly thermal transfer printers capable of printing vivid, full-color images, in recent years. Thermal transfer printers use a dye thermal transfer sheet, having a dye layer containing a dye which is transferred by sublimation or molten dispersion as a result of heating (referred to as an “ink ribbon”), and an image receiving layer on one side of a film support which receives the dye of the thermal transfer sheet (simply referred to as a “receiving layer”), to form an image by superimposing the dye layer and the receiving layer and transferring the dye at required locations of the dye layer to the receiving layer at predetermined concentrations using heat supplied from a thermal head and so forth. In particular, dye thermal transfer systems using a sublimating dye enable prints of high image quality, enabling them to take the place of silver nitrate photographs.

Single-leaf sheets or roll sheets are used for the receiving sheet depending on the type of printer. Although single-leaf sheets offer advantages such as greater ease of handling when using a small number of sheets and elimination of the need for the printer to cut the sheets, they are susceptible to the occurrence of paper feeding problems such as so-called double feeding in which two or more single-leaf sheets are fed to the printer all at once when they are fed to the printer. On the other hand, although roll receiving sheets are free of double feeding and other problems attributable to defective paper feeding, allow the printing area to be set relative to the direction of roll movement during printing, and can be produced inexpensively since there is no need to cut the roll sheet into single-leaf sheets in advance, they are difficult to handle when printing only a smaller number of sheets, and require the roll sheet to be cut by the printer.

Factors such as the coefficient of friction between receiving sheets, coefficient of friction between the receiving sheet and transport roller, as well as thickness, dimensional stability and curling of the receiving sheet are important for ensuring problem-free feeding, printing and discharge of receiving sheets. In particular, curling of the receiving sheet is a major cause of printing, feeding and discharge problems. If curling of the printed surface of a receiving sheet is excessively great, the receiving sheet ends up getting caught on the transfer rollers and guides inside the printer causing it to become jammed. In addition, there is also the risk of poor adhesion with the thermal head during printing.

As a result of being subjected to considerable heat from the thermal head during printing, the receiving sheet undergoes thermal deformation resulting in curling after printing, causing defective paper discharge and impairing the appearance of the printed receiving sheet. This thermal deformation appears in the form of curling of the receiving sheet as a result of contraction of the receiving layer itself as well as contraction of the oriented film used as the support of the receiving sheet in the direction of orientation due to residual stress from when the film was oriented. In addition, curling is also caused by deformation due to pressure applied from the thermal head and platen roller, as well as deformation caused by tension during paper feeding.

Attempts to improve curl after printing have used supports for the receiving sheet consisting of a plastic film laminated onto cellulose fiber paper, resin laminated onto cellulose fiber paper, and a support composed of a resin film in which the thermal shrinkage of the resin film is 2.0% or less (see, for example, Japanese Unexamined Patent Publication No. H6-15975 (page 2) and Japanese Unexamined Patent Publication No. H7-125466 (page 2)). However, due to the large shrinkage stress caused by heat during printing, simply increasing the quality or rigidity of the support has little effect on improving curl after printing. In addition, in order solve this problem, a receiving sheet was proposed provided with a resin layer on the back of the support (see, for example, Japanese Unexamined Patent Publication No. H8-169186 (page 2) and Japanese Unexamined Patent Publication No. H6-135024 (page 2)). However, due to the large shrinkage stress caused by heat during printing, effects for improving curl after printing are typically unable to be adequately obtained.

Moreover, a method has been proposed in which the back of the receiving sheet is wound onto the surface of a platen roller prior to printing to impart a fixed degree of curling prior to paper feeding (see, for example, Japanese Unexamined Patent Publication No. H7-124459 (page 2)). However, even if curling of the receiving sheet is controlled before printing, due to the considerable effects of shrinkage stress caused by heat during printing, there were limitations on the extent to which curl after printing can be improved.

In addition, with respect to controlling curling of roll receiving sheets, a rolled thermal transfer receiving sheet has been proposed in which the receiving layer is provided on a film base material containing a microvoid layer, and the receiving layer is wound so as to be on the outside of the roll (see, for example, Japanese Unexamined Patent Publication No. H8-20170 (pages 2-4) and Japanese Unexamined Patent Publication No. H11-139010 (pages 2-4)). For example, in Japanese Unexamined Patent Publication No. H8-20170, a polypropylene plastic film containing microvoids is disclosed, and curling before and after printing are controlled by adjusting modulus of elasticity, thermal shrinkage and so forth. However, this method is not always suitable in cases in which the material and composition of the sheet support differ as in the present invention.

Moreover, in order to solve the problem of curl after printing, a receiving sheet has been proposed which is formed into a roll with the receiving layer on the inside (see, for example, Japanese Unexamined Patent Publication No. H10-193816 (pages 2-3)). In this method, although the printed surface of the receiving layer is resistant to damage, since the receiving sheet is rolled with the receiving layer on the inside, curling occurs in the receiving sheet prior to printing, and since the receiving layer side is subjected to -shrinkage due to heat during printing, large top curls occur with the receiving layer on the inside when the receiving sheet is cut after printing. Although a method has been indicated for correcting curling by providing the top and bottom of the receiving sheet support with different physical properties and so forth, adequate effects were not obtained.

### DISCLOSURE OF THE INVENTION

As has been described above, an object of the present invention is to provide a method for printing a receiving sheet using a thermal printer, and particularly a dye thermal transfer type of printer, in which there is little curling of the receiving sheet after printing, the receiving sheet is handled easily and has a superior appearance, and printed images equivalent to silver nitrate photographs can be obtained.

The present invention includes each of the following modes in one aspect thereof.

1. A printing method for a thermal transfer receiving sheet in which an image is formed on an image transfer layer of the receiving sheet by superimposing the receiving sheet onto a dye thermal transfer sheet and applying thereto heat from a thermal head of a thermal transfer printer; wherein, the thermal transfer printer has a thermal head and a platen roller in opposition thereto, and the following requirements (1) and (2) are satisfied simultaneously:

(1) the ratio (L/R) of the length of the entire thermal transfer receiving sheet (L) to the radius (R) of the platen roller of the printer is 0.01 to 0.07; and,

(2) after a thermal transfer image has been formed on the image receiving layer by the thermal head, the thermal transfer receiving sheet is transported by the back side thereof being wound onto the surface of the platen roller, and the winding angle is 2 to 25°.

2. The printing method for a thermal transfer receiving sheet according to 1 above, wherein the thermal shrinkage of the thermal transfer receiving sheet at 100° C. as determined according to JIS C2151 is 0.05 to 1.0%.

3. The printing method for a thermal transfer receiving sheet according to 1 or 2 above, wherein the thermal transfer receiving sheet is provided with the image receiving layer on at least one side of a sheet-like support having a laminated structure consisting of at least three layers in which a thermoplastic resin film containing a porous structure is laminated on both sides of a core material layer.

4. The printing method for a thermal transfer receiving sheet according to 3 above, wherein the thermal shrinkage at 100° C. of the thermoplastic resin film on the side on which the image receiving layer is formed as determined according to JIS C2151 is 0.05 to 1.0%.

5. The printing method for a thermal transfer receiving sheet according to 1 above, wherein the thermal transfer receiving sheet is a thermal transfer receiving sheet in which an intermediate layer containing hollow particles and an image receiving layer are sequentially formed on at least one side of a paper base material, the thickness of the entire thermal transfer receiving sheet is 100 to 300 μm, and the ratio (%) of the thickness of the paper material to the thickness of the entire thermal transfer receiving sheet is 70 to 85%.

6. The printing method for a thermal transfer receiving sheet according to 5 above, wherein the Gurley stiffness of the thermal transfer receiving sheet in the direction in which paper is fed to the printer as defined in TAPPI TR543 84 is 500 to 2000 SGU.

Moreover, the present invention includes the each of the following modes in a second aspect thereof.

7. A printing method for a thermal transfer receiving sheet in which an image is formed on an image receiving layer of the receiving sheet by superimposing the receiving sheet onto a dye thermal transfer sheet and applying thereto heat from a thermal head of a thermal transfer printer; wherein, the thermal transfer receiving sheet is a rolled thermal transfer receiving sheet wound with the image receiving layer on the inside, and curl correction treatment is carried out before forming an image and/or after having formed an image on the thermal transfer receiving sheet.

8. The printing method for a thermal transfer receiving sheet according to 7 above, wherein the curl correction treatment is carried out by contacting the surface of a decurling roller with the back of the thermal transfer receiving sheet (side not provided with an image receiving layer), and applying stress to the thermal transfer receiving sheet.

9. The printing method for a thermal transfer receiving sheet according to 8 above, wherein at least one of the decurling rollers has a diameter of 30 mm or less, and the winding angle of the thermal transfer receiving sheet which contacts the decurling roller is 20 to 180°.

10. The printing method for a thermal transfer receiving sheet according to any of 7 to 9 above, wherein the thermal transfer receiving sheet is wound onto a take-up roller having an outer diameter of 30 to 110 mm, and the outer diameter of the rolled thermal transfer receiving sheet is 60 to 230 mm.

11. The printing method for a thermal transfer receiving sheet according to any of 7 to 10 above, wherein the thermal transfer receiving sheet has an intermediate layer containing hollow particles and the image receiving layer sequentially provided on at least one side of a sheet-like support having cellulose pulp as its main component.

Moreover, the present invention includes each of the following modes.

12. A printing method for a thermal transfer receiving sheet in which an image is formed on an image receiving layer of the receiving sheet by superimposing the receiving sheet onto a dye thermal transfer sheet and applying thereto heat from a thermal head of a thermal transfer printer; wherein, the thermal transfer receiving sheet is a rolled thermal transfer receiving sheet wound with the image receiving layer on the inside, curl correction treatment is carried out before forming the image and/or after having formed the image on the thermal transfer receiving sheet, the thermal transfer printer has a thermal head and a platen roller in opposition thereto, and the following requirements (1) and (2) are satisfied simultaneously.

(1) the ratio (L/R) of the length of the entire thermal transfer receiving sheet (L) to the radius (R) of the platen roller of the printer is 0.01 to 0.07; and,

(2) after the thermal transfer image has been formed on the image receiving layer by the thermal head, the thermal transfer receiving sheet is transported by the back side thereof being wound onto the surface of the platen roller, and the winding angle is 2 to 25°.

13. The printing method for a thermal transfer receiving sheet according to 12 above, wherein the thermal shrinkage of the thermal transfer receiving sheet at 100° C. as determined according to JIS C2151 is 0.05 to 1.0%.

14. The printing method for a thermal transfer receiving sheet according to 12 or 13 above, wherein the thermal transfer receiving sheet is provided with the image receiving layer on at least one side of a sheet-like support having a laminated structure consisting of at least three layers in which a thermoplastic resin film containing a porous structure is laminated on both sides of a core material layer.

15. The printing method for a thermal transfer receiving sheet according to 14 above, wherein the thermal shrinkage at 100° C. of the thermoplastic resin film on the side on which the image receiving layer is formed as determined according to JIS C2151 is 0.05 to 1.0%.

16. The printing method for a thermal transfer receiving sheet according to 12 above, wherein the thermal transfer receiving sheet is a thermal transfer receiving sheet in which an intermediate layer containing hollow particles and an image receiving layer are sequentially formed on at least one side of a paper base material, the thickness of the entire thermal transfer receiving sheet is 100 to 300 μm, and the ratio (%) of the thickness of the paper material to the thickness of the entire thermal transfer receiving sheet is 70 to 85%.

17. The printing method for a thermal transfer receiving sheet according to 16 above, wherein the Gurley stiffness of the thermal transfer receiving sheet in the direction in which paper is fed to the printer as defined in TAPPI TR543 84 is 500 to 2000 SGU.

18. The printing method for a thermal transfer receiving sheet according to any of 12 to 17 above, wherein the curl correction treatment is carried out by contacting the surface of a decurling roller with the back of the thermal transfer receiving sheet (side not provided with an image receiving layer), and applying stress to the thermal transfer receiving sheet.

19. The printing method for a thermal transfer receiving sheet according to 18 above, wherein at least one of the decurling rollers has a diameter of 30 mm or less, and the winding angle of the thermal transfer receiving sheet which contacts the decurling roller is 20 to 180°.

20. The printing method for a thermal transfer receiving sheet according to any of 12 to 19 above, wherein the thermal transfer receiving sheet is wound onto a take-up roller having an outer diameter of 30 to 110 mm, and the outer diameter of the rolled thermal transfer receiving sheet is 60 to 230 mm.

21. The printing method for a thermal transfer receiving sheet according to any of 12 to 20 above, wherein the thermal transfer receiving sheet has an intermediate layer containing hollow particles and the image receiving layer sequentially provided on at least one side of a sheet-like support having cellulose pulp as its main component.

According to the thermal transfer printing method of the present invention, printed matter having a superior appearance can be obtained with hardly any curling of the receiving sheet after printing and easy handling of the receiving sheet.

### BRIEF DESCRIPTION OF THE DRAWINGS

FIG. 1 is a schematic drawing for explaining a printing method as claimed in a first aspect of the present invention; and,

FIG. 2 is a schematic drawing for explaining a printing method as claimed in a second aspect of the present invention, with (1) indicating a method for carrying out curl correction prior to printing, and (2) indicating a method for carrying out curl correction after printing.

### BEST MODE FOR CARRYING OUT THE INVENTION

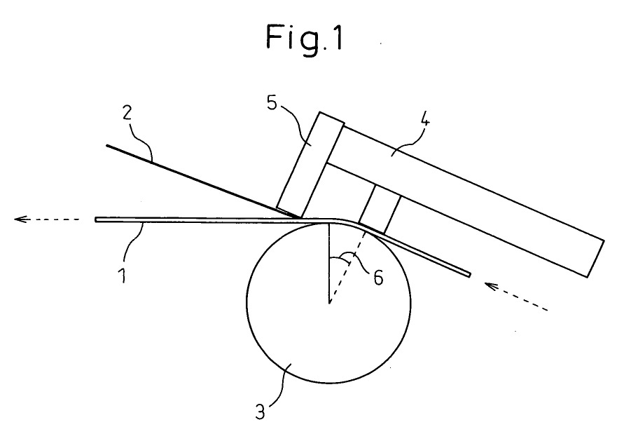

Although FIG. 1 shows a schematic representation of a printing method using a thermal transfer printer as claimed in a first aspect of the present invention, the present invention is not limited thereto. A thermal transfer printer has a thermal head 4 and a platen roller 3 in opposition thereto, paper is fed with an ink layer of an ink ribbon 2 superimposed on an image receiving side of a receiving sheet 1, and after being printed by the thermal head 4, is transported while maintaining a constant winding angle 6 by a guide 5 in the state in which the back of the receiving sheet is in contact with the outer periphery of the platen roller.

With respect to the direction of curling of the receiving sheet in the present invention, the case of a convex curl on the receiving layer side when the receiving sheet is placed on a horizontal surface with the receiving layer side facing upward is referred to as a top curl, while the cases of a concave curl on the receiving layer side (or concave curl on the back side) when the receiving sheet is placed on a horizontal surface with the receiving layer side facing upward is referred to as a back curl.

When printing onto the receiving layer side of a receiving sheet using a thermal transfer printer, the receiving layer itself and the receiving layer side of the support are heated selectively. The receiving layer itself and the receiving layer side of the support demonstrate thermal shrinkage force in a direction perpendicular to the direction of travel of the receiving sheet, thereby causing top curl. For example, although the receiving layer itself and the receiving layer side of the support attempt to demonstrate thermal shrinkage in the direction of travel of the receiving sheet, as a result of winding the back of the receiving sheet so as to contact the platen roller after printing, bending stress is generated in the receiving sheet, thereby enabling thermal elongation by the receiving layer itself and the receiving layer side of the support.

The degree of thermal elongation differs according to the degree of winding onto the platen roller, and since the degree of winding becomes greater the larger the angle at which the printed receiving sheet is transported to the platen roller along the tangent of the location where contacted by the thermal head on the platen roller, the degree of thermal elongation also increases. In addition, the degree of thermal elongation also differs according to the diameter of the platen roller and thickness of the receiving sheet, and the degree of thermal elongation increases the smaller the diameter of the platen roller and the larger the thickness of the receiving sheet. For example, in the case of assuming that a receiving sheet elongates more moving towards the receiving layer side when immobilized at the contact point with the platen roller as a result of winding a receiving sheet of thickness (L) onto a platen roller of radius (R), then the elongation ratio of the outermost receiving layer becomes L/R. In other words, the degree of thermal elongation increases the larger the ratio of L/R.

As has been described above, top curl attempts to occur in the case of shrinkage of the receiving layer itself and the receiving layer side of the support, while back curl attempts to occur in the case of thermal elongation of the receiving layer itself and the receiving layer side of the support.

Curling of the receiving layer after printing is determined by degree of overlapping of a top curl component in a direction perpendicular to the direction of travel of the receiving sheet, and a top or back curl component in the direction of travel of the receiving sheet. In other words, the sheet demonstrates a top curl if the direction of travel of the receiving sheet has a top curl component, while the sheet demonstrates a back curl if the direction of travel of the receiving sheet has a back curl component, and that back curl component is larger than the top curl component in a direction perpendicular to the direction of travel of the receiving sheet.

In order to obtain a suitable back curl or suitable top curl immediately after printing a receiving sheet using a thermal transfer printer, it is necessary for the thermal transfer printer to have a thermal head and a platen roller in opposition thereto, and simultaneously satisfy the following requirements (1) and (2):

(1) the ratio (L/R) of the length of the entire receiving sheet (L) to the radius (R) of the platen roller of the printer is 0.01 to 0.07; and,

(2) after a thermal transfer image has been formed on the image receiving layer by the thermal head, the thermal transfer receiving sheet is transported by the back side thereof being wound onto the surface of the platen roller, and the winding angle is 2 to 25°.

If the winding angle is less than 2°, since the effect of platen winding are unable to be adequately obtained, the receiving layer side of the receiving sheet shrinks due to the heat from the thermal head, and the top curl of the receiving sheet increases. On the other hand, if the winding angle exceeds 25°, since the direction of travel of the receiving sheet has a large back curl component, the back curl of the receiving sheet increases. Thus, the winding angle is preferably 2 to 20° and more preferably 5 to 15°.

The direction in which the receiving sheet is transported after printing is preferably an angle of about 2 to 25° towards the platen roller from the direction of the tangent at the location contacted by the thermal head on the platen roller.

Moreover, if the ratio of L/R is less than 0.01, the back curl component in the direction of travel of the receiving sheet becomes smaller, and the top curl component of the receiving sheet increases. On the other hand, if the ratio of L/R exceeds 0.07, since the direction of travel of the receiving sheet has a large back curl component, the back curl of the receiving sheet also increases. Moreover, the ratio of L/R is preferably within the range of 0.02 to 0.05.

The radius (R) of the platen roller is preferably 4 to 50 mm, and more preferably 5 to 15 mm. If R is less than 4 mm, the adhesion between the thermal head and receiving layer becomes inadequate resulting in poor image quality. On the other hand, if R exceeds 50 mm, adequate curling control effects are unable to be obtained even if the winding angle is increased.

In addition, thickness (L) of the receiving sheet is preferably 100 to 300 μm, and more preferably 150 to 250 μm. If L is less than 100 μm, the bending stress of the receiving sheet generated as a result of winding onto the platen roller decreases, thereby preventing the obtaining of curling control effects. In addition, if L exceeds 300 μm, the bending stiffness of the receiving sheet becomes excessively large, thereby preventing the receiving sheet from being wound uniformly and the formation of bending wrinkles when wound onto the platen roller.

If the axis of curling of the receiving sheet prior to printing (to be simply referred to as “pre-printing curl”) is parallel to the direction of feeding and discharge of the thermal transfer printer, the adhesion between the receiving sheet and printer thermal head during printing becomes inferior, resulting in poor image quality. The maximum value of curl height at the four corners of the receiving sheet before printing is preferably 15 mm or less for both top curl and back curl. If the maximum value of curl height at the four corners of the receiving sheet before printing exceeds 15 mm for top curl or back curl, defective paper feeding or defective passage through the printer may occur.

In order to control the pre-printing curl to within a preferable range, the support of the receiving sheet preferably has a symmetrical structure with respect to the direction of thickness, and for example, preferably has a laminated structure consisting of at least three layers in which thermoplastic resin films are laminated on a core material layer. The film laminated on both sides preferably has the same thickness on the top and bottom and is made of the same material, and more preferably the same film is laminated on the top and bottom.

(Film Support)

Various base materials have been developed for use as sheet-like supports to improve curling of the receiving sheet after printing, and various constitutions have been disclosed, such as control of thermal shrinkage by heat treatment and so forth, or laminating various types of base materials.

There are no particular limitations on the receiving sheet of the present invention, and typically used receiving sheets are suitable for the printing method of the present invention. Normally, the thermal shrinkage at 100° C. of the film support used in a receiving sheet is about 0.05 to 1.0%, and the thermal shrinkage of the resulting receiving sheet is also within the same range, and preferably within the range of 0.2 to 0.7%.

In addition, in film-laminated support, the thermal shrinkage at 100° C. of a thermoplastic resin film at least on the side on which the receiving layer is formed (surface layer base material) is preferably 0.05 to 1.0%. If the thermal shrinkage of the thermoplastic resin film exceeds 1.0%, dimensional stability decreases, shrinkage occurs over time, and curling occurs in the receiving sheet. On the other hand, if the thermal shrinkage of the thermoplastic resin film is less than 0.05%, in addition to being difficult to acquire, the stiffness of the thermoplastic resin film is insufficient due to inadequate orientation treatment, thereby resulting in inferior texture of the receiving sheet. Furthermore, thermal shrinkage as referred to in the present invention indicates the value measured at a heating temperature of 100° C. after heating for 30 minutes in compliance with JIS C 2151.

A sheet-like support having a laminated structure consisting of at least three layers in which thermoplastic resin films are laminated onto both sides of a core material layer, for example, is preferably used for the sheet-like support used in the receiving sheet of the present invention. Examples of the thermoplastic resin films used include non-porous oriented films or porous oriented films made of polyolefin or polyester.

From the viewpoints of printing density, uniformity of printed images, contrast, film heat resistance and so forth, the surface layer base material of film-laminated sheet-like support (base material on the side on which the receiving layer is formed) is preferably a film having for its main component a polyester resin such as polyethylene terephthalate, polybutylene terephthalate or polyethylene naphthalate, and particularly preferably a film having for its main component a polyethylene terephthalate resin. More specifically, a porous oriented polyester film having a single-layer or multilayer structure and containing a layer comprised of a porous structure in which a polyester resin such as polyethylene terephthalate or polybutylene terephthalate is mixed with a resin incompatible therewith (or an inorganic pigment may also be added as necessary) followed by orienting this resin mixture to form voids, is used preferably. Furthermore, a porous oriented film having a porous structure refers to a multilayer film having two or more layers containing at least one layer having a porous structure within the film, and all of the layers which composed the film may have a porous structure, or layer or layers may be present which do not have a porous structure.

A homopolymer comprised of terephthalic acid and ethylene glycol, or a copolymer obtained by copolymerizing a third component with terephthalic acid and ethylene glycol can be used for the polyester film used for the surface layer base material of the film-laminated sheet-like support. These types of copolymers are known, and examples of third components used include oxycarboxylic acids such as p-hydroxybenzoic acid, aromatic dicarboxylic acids such as isophthalic acid and naphthalene dicarboxylic acid, and polyalkylene glycols such as propylene glycol and tetramethylene glycol. In addition, the polyester film is preferably oriented, and this oriented polyester film preferably has a porous structure to enhance cushioning and heat insulation.

In order to form a porous structure in the polyester resin, an incompatible resin is uniformly dispersed in the polyester resin (along with inorganic fine powder depending on the case) followed by orienting the film formed from this resin composition. Examples of resins incompatible with polyester resin include, but are not limited to, polyolefins such as polyethylene or polypropylene, polystyrene, polybutadiene, polyacrylonitrile and copolymers thereof. Examples of inorganic fine powders contained in the polyester resin include calcium carbonate, magnesium oxide, titanium oxide, magnesium carbonate, aluminum hydroxide, sodium aluminosilicate, potassium aluminosilicate, clay, mica, talc, barium sulfate and calcium sulfate, and these may be used alone or two or more types may be used as a mixture.

The thickness of the surface layer base material of a porous oriented polyester film and so forth is preferably 25 to 75 μm, and more preferably 35 to 55 μm. If the thickness of the surface layer base material is less than 25 μm, it becomes difficult to produce a film, and is disadvantageous in terms of costs. If the thickness exceeds 75 μm, due to the high rigidity of the film, the texture of the resulting receiving sheet tends to differ from the paper, thereby making this undesirable.

In addition, a thermoplastic resin film or paper having a smooth surface is preferable for the core material layer of the film-laminated sheet-like support. Specific examples thereof include, but are not limited to, porous oriented polyester film, non-porous oriented polyester film, porous oriented polyolefin film, non-porous oriented polyolefin film, high-quality paper and coated paper.

A film having for its main component an ethylene resin such as high-density polyethylene or medium-density polyethylene, propylene resin or methyl-1-pentene resin, for example, is used for the porous oriented polyolefin film used in the core material layer of the present invention. The use of a film having for its main component a propylene resin is preferable from the viewpoints of chemical resistance and cost. Propylene homopolymers and copolymers of propylene and α-olefins can be used for the propylene resin. The propylene resin used preferably incorporates 2 to 25% by weight of a resin having a lower melting point than a propylene homopolymer (such as high-density to low-density polyethylene). In addition, the polyolefin film is preferably oriented, and this oriented polyolefin film preferably has a porous structure to enhance cushioning and heat insulation.

In order to form a porous structure in the polyolefin resin, an inorganic fine powder and/or organic filler is uniformly dispersed in the polyolefin resin followed by orienting the film formed from this resin composition. Examples of organic fine powders contained in the polyolefin resin include calcium carbonate, magnesium oxide, titanium oxide, magnesium carbonate, aluminum hydroxide, sodium aluminosilicate, potassium aluminosilicate, clay, mica, talc, barium sulfate and calcium sulfate, and these may be used alone or two or more types may be used as a mixture.

In the case of adding an organic filler, a different type of resin from the polyolefin resin serving as the main component is preferably selected. Examples of organic fillers contained in the polyolefin resin include polyethylene terephthalate, polybutylene terephthalate, polycarbonate, Nylon 6, polystyrene and polymethyl methacrylate, and a polymer can be used which has a higher melting point or higher glass transition point temperature than the melting point of the polyolefin resin.

A porous oriented polyester film as described in the section describing the surface layer base material of the sheet-like support (base material on the side on which the receiving layer is formed) can be used for the porous oriented polyester film used in the core material layer of the present invention. In addition, a non-porous oriented polyester film can be obtained by orienting a film formed from a resin composition not containing an incompatible resin in the polyester film. In addition, examples of paper used in the core material layer of the present invention include high-quality paper and coated paper. Paper cast with a mirrored surface and paper subjected to calender treatment are preferable due to their high smoothness.

Furthermore, the thickness of the core material layer is preferably 30 to 200 μm, and more preferably 50 to 150 μm. If the thickness of the core material layer is less than 30 μm, the stiffness of the film becomes lacking in the production process of the laminated structure support, thereby resulting in poor workability. In addition, if the thickness of the core material layer exceeds 200 μm, the overall thickness of the resulting receiving sheet becomes excessive, thereby causing the rigidity of the receiving sheet to be excessively high.

A sheet or film of the same material as the surface layer base material is preferably used for the bottom base material of the film-laminated sheet-like support (base material on the opposite side from the side on which the receiving layer is formed) from the viewpoint of preventing curling. A support having a porous oriented polyolefin film (synthetic paper) for the core material, and a laminated structure in which a porous oriented polyester film is laminated on the top and bottom is used particularly preferably for the sheet-like support of the present invention.

There are no particular limitations on the lamination method used when forming the film-laminated sheet-like support, and a known technology such as wet lamination, extrusion lamination, dry lamination or wax lamination may be used, while dry lamination or extrusion lamination are used typically. An adhesive such as a polyester, polyether or polyurethane adhesive can be used for the dry lamination adhesive. A polyolefin resin such as a polyethylene or polypropylene resin is used for the adhesive used during extrusion lamination.

(Anchoring Intermediate Layer)

Primarily in the case of a film-laminated sheet-like support, an anchoring intermediate layer (also referred to as an “anchor layer”) may be provided between the sheet-like support and the receiving layer to improve adhesion between the sheet-like support and the receiving layer as well as prevention of accumulation of charge in the receiving sheet. Various types of hydrophilic resins and hydrophobic resins can be used to form this anchor layer, examples of which include vinyl polymers and derivatives thereof such as polyvinyl alcohol or polyvinyl pyrrolidone, polymers containing an acrylic group such as polyacrylamide, polydimethylacrylamide, polyacrylic acid and salts thereof or polyacrylic acid esters, polymers containing a methacrylic group such as polymethacrylic acid or polymethacrylic acid esters, polyester resins, polyurethane resins, starch, modified starch and resins of cellulose derivatives such as carboxymethyl cellulose.

Various known assistants such as antistatic agents, crosslinking agents, thickeners, lubricants, mold release agents, antifoaming agents, wetting agents, leveling agents, and whiteners can also be added to the anchor layer as necessary. A conducting agent such as a conductive resin or conductive inorganic pigment is added for the antistatic agent. Examples of conductive resins include cationic, anionic and nonionic conductive resins, with cationic conductive resins being used preferably. Examples of cationic conductive resins include polyethyleneimine, acrylic polymers containing cationic monomers, cationic modified acrylamide polymers and cationic starch. An isocyanate crosslinking agent or epoxy crosslinking agent is preferably added for the crosslinking agent to improve the moisture resistance and solvent resistance of the anchor layer.

The amount of coated solid of the anchor layer is preferably within the range of 0.2 to 5 g/m², and more preferably within the range of 0.5 to 3 g/m². Incidentally, if the amount of coated solid is less than 0.2 g/m², the effect of the anchor layer of improving adhesion is diminished, while if the amount of coated solid exceeds 5 g/m², blocking and workability decrease.

The sheet-like support used in the present invention preferably has a thickness of 100 to 300 μm. Incidentally, if the thickness is less than 100 μm, the mechanical strength thereof becomes inadequate, the rigidity of the receiving sheet obtained there from decreases, and has inferior quality as a receiving sheet. In addition, if the thickness exceeds 300 μm, the thickness of the resulting receiving sheet becomes excessively large, and in the case of single-leaf sheets, leads to increased volume of the paper cassette, while in the case of a rolled receiving sheet, for example, leads to increased volume of the printer which is to house the predetermined roll length, thereby resulting in problems such as making it difficult to make the printer compact.

The sheet-like support used in the present invention may have a constitution in which a first base material layer on which a receiving sheet is formed, a pressure-sensitive adhesive layer, a release agent layer and a second base material layer are sequentially laminated, and a support having a label type structure (so-called sticker or seal type) can naturally also be used. A back layer may also be provided on the back of the second base material.

(Paper Base Material)

Moreover, a paper base material can be used for the sheet-like support of the present invention. Paper having its main component cellulose pulp is used preferably due to its low level of thermal shrinkage, satisfactory insulating properties, satisfactory texture as a receiving paper, and low cost. A receiving sheet having, for example, an intermediate layer containing hollow particles between a paper base material having for its main component cellulose pulp and a receiving layer (to also be referred to as a “hollow particle-containing intermediate layer”) is used more preferably. A certain degree of rigidity is required to obtain adequate effects of curl correction treatment in a receiving sheet having a paper base material for the support, and is suitably adjusted according to, for example, the thickness of the receiving sheet, and ratio of the thickness of the sheet-like support to the thickness of the receiving sheet.

The Gurley stiffness of the receiving sheet in the direction in which paper is fed to the printer (namely, the direction equivalent to the printing direction) as defined in TAPPI TR543 84 is preferably 500 to 2000 SGU, more preferably 600 to 1800 SGU, and even more preferably 700 to 1700 SGU. If the Gurley stiffness in the direction in which paper is fed to the printer is less than 500 SGU, it is difficult for plastic deformation to occur, thereby preventing the obtaining of curl correction effects. In the case the Gurley stiffness in the direction in which paper is fed to the printer exceeds 2000 SGU, a large amount of energy is required to correct curling, and adequate correction effects may be unable to be obtained even if wound onto the platen roller. Although the amount of curl deformation can be increased if tension is increased so as to strongly press onto the platen roller, since it becomes necessary to increase the nip of the transport roller, the surface of the receiving sheet may be damaged or wrinkles may form in the surface of the receiving sheet if the receiving sheet is forcibly curled.

The thickness of the receiving sheet is preferably 100 to 300 μm, and more preferably 150 to 260 μm. If the thickness of the receiving sheet is less than 100 μm, since the difference in the amount of deformation between the inside and outside of the receiving sheet during winding is small, it is difficult for plastic deformation to occur even if wound onto the platen roller, mechanical strength is inadequate, the rigidity of the resulting receiving sheet is low, and the texture as a receiving sheet is inferior. If the thickness of the receiving sheet exceeds 300 μm, wrinkles form easily since the difference in the amount of deformation between the inside and outside of the receiving sheet during winding is excessively large. In the case of single-leaf sheets, this leads to an increase in the volume of the paper cassette, while in the case of a rolled receiving sheet, for example, this leads to increased volume of the printer which is to house the predetermined roll length, thereby resulting in problems such as making it difficult to make the printer compact.

In addition, the ratio ((W/L)×100%) of the thickness (W) of the paper base material to the thickness (L) of the entire receiving sheet is preferably 70 to 85%. If the ratio of W/L is less than 70%, it is not possible to control curling by winding onto the platen roller, or in other words, since the deformation caused by winding into the platen roller mainly occurs due to deformation of the paper base material, it becomes difficult to obtain curl correction effects. On the other hand, if the ratio of W/L exceeds 85%, the thickness of the hollow particle-containing intermediate layer is inadequate, resulting in the occurrence of printing omissions caused by poor adhesion with the head, or printing unevenness occurs due to the effects of the texture of the base paper, thereby resulting in the risk of decreased image quality.

Examples of paper base materials suitably used in the present invention include paper having for its main component cellulose pulp, such as woodfree paper (such as acidic paper or neutral paper), medium quality paper, coated paper, art paper, glassine paper, cast coated paper, laminated paper provided with a polyolefin resin or other thermoplastic resin layer on at least one side thereof, synthetic resin-impregnated paper, emulsion-impregnated paper, synthetic rubber latex-impregnated paper, synthetic resin internally added paper, foamed paper containing thermally expansible particles, and paperboard.

(Hollow Particle-Containing Intermediate Layer)

Since the hollow particle-containing intermediate layer in the present invention has high cushioning as a result of having a porous structure having as main components thereof a binder resin and hollow particles, a highly sensitive receiving sheet is obtained even in the case of using a paper base material for the sheet-like support. As a result of containing hollow particles in the intermediate layer, a suitable degree of freedom of deformation is imparted to the receiving sheet, the ability of the receiving sheet to follow the shape of the printer head and the shape of the ink ribbon and adhere thereto is improved, thereby improving the thermal efficiency of the thermal head with respect to the receiving layer even under low energy conditions, while also being able to increase printing density and improve image quality. In addition, printing errors caused by the formation of wrinkles in the ink ribbon occurring during high-energy printing by high-speed printers can also be simultaneously prevented.

The hollow particles used in the hollow particle-containing intermediate layer of the present invention are composed of a shell formed from a polymer material and one or more hollow portions surrounded thereby, and although there are no particular limitations on the method used to produce these hollow particles, they can be selected from those produced in the manner described in (a) and (b) below.

(a) Foamed hollow particles produced by causing thermal expansion of a thermoplastic polymer material containing a thermally expanding substance (to also be referred to as “foamed hollow particles”).

(b) Microcapsule hollow particles obtained by using a polymer-forming material as the material for forming the shell, using a volatile liquid as the material for forming pores, and volatizing and dissipating the material for forming pores from microcapsules produced by microcapsule polymerization.

The mean particle diameter of the hollow particles used in the present invention is 0.2 to 30 μm, preferably 0.5 to 10 μm, and more preferably 0.8 to 8 μm. If the mean particle diameter of the hollow particles is less than 0.2 μm, heat insulation and cushioning are generally low due to the low volumetric hollow ratio of the resulting hollow particles, thereby preventing effects of improving sensitivity and image quality from being adequately obtained. In addition, if the mean particle diameter exceeds 30 μm, the smoothness of the surface of the resulting hollow particle-containing intermediate layer decreases while surface irregularities in the receiving sheet increase, thereby resulting in inadequate uniformity of thermal transfer images and inferior image quality.

In addition, the maximum particle diameter of the hollow particles used in the present invention is preferably 100 μm or less, more preferably 50 μm or less, and even more preferably 20 μm or less. If the maximum particle diameter of the hollow particles exceeds 100 μm, uneven printing density and white spots occur in thermal transfer images caused by coarse particles, and image quality becomes inferior. In order to not contain coarse particles having a maximum particle diameter in excess of 100 μm among the hollow particles, in general, accommodations can be made by adjusting the set value for mean particle diameter during production of hollow particles exhibiting a normal distribution. In addition, hollow particles reliably free of coarse particles can be obtained by providing a particle sizing step. Furthermore, the particle diameter of hollow particles as described in the present specification can be measured using an ordinary particle diameter measuring instrument, and indicates the value measured using a laser diffraction type of particle distribution measuring instrument (trade name: SALD2000, Shimadzu Corp.).

The volumetric hollow ratio of the hollow particles used in the present invention is preferably 40 to 95% and more preferably 75 to 95%. If the volumetric hollow ratio is less than 40%, image quality may decrease. In addition, if the volumetric hollow ratio exceeds 95%, coating layer strength is inferior, leading to the destruction of the hollow particles during coating and drying, and resulting in decreased surface smoothness.

The blended amount of hollow particles in the hollow particle-containing intermediate layer is preferably within the range of 30 to 75% by weight, and more preferably within the range of 35 to 70% by weight, in terms of the ratio of the weight of the hollow particles to the total solid matter weight of the entire hollow particle-containing intermediate layer. If the weight ratio of the hollow particles to the total solid matter weight of the entire hollow particle-containing intermediate layer is less than 30% by weight, heat insulation and cushioning of the hollow particle-containing intermediate layer become inadequate, and the effects of improving sensitivity and image quality are not adequately obtained. In addition, if the weight ratio of the hollow particles exceeds 75% by weight, the coatability of the resulting hollow particle-containing intermediate layer coating decreases, thereby resulting in inadequate coated film strength and preventing obtaining of the desired effects.

In order for the hollow particle-containing intermediate layer to demonstrate the desired performance such as heat insulation and cushioning, the film thickness of the hollow particle-containing intermediate layer is preferably 20 to 90 μm, and more preferably 25 to 85 μm. If the film thickness of the hollow particle-containing intermediate layer is less than 20 μm, heat insulation and cushioning are deficient, and the effects of improved sensitivity and image quality are inadequate. In addition, if the film thickness exceeds 90 μm, the effects of heat insulation and cushioning are saturated, and performance beyond this level is unable to be obtained, thereby making this economically disadvantageous.

The hollow particle-containing intermediate layer of the present invention contains hollow particles and an adhesive resin. The coating for the hollow particle-containing intermediate layer of the present invention is preferably an aqueous coating in consideration of solvent resistance of the hollow particles. Thus, although both aqueous and organic solvent resins can be used for the adhesive resin, an aqueous resin is preferable. There are no particular limitations on the adhesive resin used, and hydrophilic polymer resins such as polyvinyl alcohol resins, cellulose resins and derivatives thereof, casein or starch derivatives are used preferably from the viewpoint of film formation, heat resistance and flexibility. In addition, emulsions of various types of resins such as (meth)acrylate resin, styrene-butadiene copolymer resin, urethane resin, polyester resin, and ethylene-vinyl acetate copolymer resin are used as aqueous resins having low viscosity and high solid content. Furthermore, the adhesive resin used in the hollow particle-containing intermediate layer preferably combines the use of any of the aforementioned hydrophilic polymer resins with various types of resin emulsions in terms of coated film strength, adhesion and coatability of the hollow particle-containing intermediate layer.

One or more types of various additives such as antistatic agents, inorganic pigments, organic pigments, resin crosslinking agents, antifoaming agents, dispersants, coloring dyes, release agents or lubricants may be suitably selected and used as necessary in the hollow particle-containing intermediate layer.

(Barrier Layer)

In the present invention, a barrier layer may be provided on the hollow particle-containing intermediate layer as necessary, and the receiving layer is provided on this barrier layer. The solvent of the coating for the receiving layer is generally an organic solvent such as toluene or methyl ethyl ketone, and the barrier layer is effective as a barrier for preventing destruction of the hollow particle-containing intermediate layer by penetration of organic solvent resulting from swelling and dissolution of the hollow particles. In addition, since the surface of the hollow particle-containing intermediate layer has surface irregularities caused by the hollow particles of the hollow particle-containing intermediate layer, the receiving layer provided thereon also has surface irregularities, and the resulting images frequently have white spots and uneven printing density as well as problems with image uniformity and resolution due to these surface irregularities. In order to rectify this problem, the providing of a barrier layer containing a flexible and elastic binder resin is effective for improving image quality.

A resin having superior film forming ability which prevents permeation of organic solvent and has elasticity and flexibility is used for the resin used in the barrier layer, specific examples of which include water-soluble polymer resins used in the form of an aqueous solution such as starch, modified starch, hydroxyethyl cellulose, methyl cellulose, carboxymethyl cellulose, gelatin, casein, gum arabic, fully saponified polyvinyl alcohol, partially saponified polyvinyl alcohol, carboxy-modified polyvinyl alcohol, acetoacetyl group-modified polyvinyl alcohol, diisobutylene-maleic anhydride copolymer salt, styrene-maleic anhydride copolymer salt, urea resin, urethane resin, melamine resin and amide resin. In addition, water-dispersible resins can also be used, examples of which include styrene-butadiene copolymer latex, acrylate resin latex, methacrylate copolymer resin latex, ethylene-vinyl acetate copolymer latex, polyester polyurethane ionomer, and polyether polyurethane ionomer. Among these resins, water-soluble polymer resins are used preferably. In addition, these resins may be used alone or two or more types may be used in combination.

Moreover, various types of pigments may be contained in the barrier layer, and a swelling inorganic layered compound is used preferably since it not only prevents permeation of coating solvent, but also allows the obtaining of superior effects in terms of preventing bleeding of thermal transfer dye images. Specific examples of swelling inorganic layered compounds include graphite, phosphate derivative compounds (such as zirconium phosphate compounds), chalcogen compounds, hydrotalcite compounds, lithium-aluminum composite hydroxides, and clay minerals (such as synthetic mica, synthetic smectite, smectite group, vermiculite group and mica group minerals).

These swelling inorganic layered compounds may be naturally-occurring compounds (clay minerals) as well as synthetic or processed compounds (such as products of surface treatment with a silane coupling agent). Preferable examples of synthetic swelling organic layered compounds include synthetic mica such as fluorphlogopite, potassium tetrasilic mica, sodium tetrasilic mica, sodium taenioloite or lithium taenioloite, and synthetic smectite such as sodium hectorite, lithium hectorite or saponite, with sodium tetrasilic mica being particularly preferable, and these are obtained having a desired particle diameter, aspect ratio and crystallinity depending on the melting method.

The barrier layer of the present invention is preferably formed using an aqueous coating liquid. This aqueous coating liquid preferably does not contain an excess amount of organic solvent, including ketone solvents such as methyl ethyl ketone, ester solvents such as ethyl acetate, lower alcohol solvents such as methyl alcohol or ethyl alcohol, hydrocarbon solvents such as toluene or xylene, or high boiling point and high-polarity solvents such as DMF or cellusorb, to prevent swelling and decomposition of the hollow particles. The amount of solid coating component in the barrier layer is preferably within the range of 0.5 to 10 g/m², and more preferably within the range of 1 to 8 g/m². Incidentally, if the amount of solid coating component in the barrier layer is less than 0.5 g/m², the barrier layer may not be able to completely cover the surface of the hollow particle-containing intermediate layer, thereby preventing it from being adequately effective in preventing permeation of organic solvent. On the other hand, if the solid coating component of the barrier layer exceeds 10 g/m², coating effects are saturated, which in addition to being uneconomical, the excessive thickness of the barrier layer prevents insulation and cushioning effects from being adequately demonstrated by the hollow particle-containing intermediate layer, resulting in a decrease in image density.

(Receiving Layer)

In a receiving sheet of the present invention, a receiving layer, which is provided on a sheet-like support either directly or with a hollow particle-containing intermediate layer there between, is formed by applying a coating, containing a resin having dyeing affinity as a main component thereof and to which is suitably added as necessary one or more types of crosslinking agents, anti-sticking agents or ultraviolet absorbers, onto the surface of the hollow particle-containing layer or the sheet-like support followed by drying and crosslinking.

A resin having satisfactory affinity for dye and a high dyeing affinity is used as the resin having dyeing affinity used in the receiving layer of the present invention. Examples of such resins include polyester resin, polycarbonate resin, polyvinyl chloride resin, vinyl chloride-vinyl acetate copolymer resin, polyvinyl acetal resin, polyvinyl butyral resin, polystyrene resin, polyacrylate resin, cellulose acetate phthalate and other cellulose derivative resins, polyamide resin and other thermoplastic resins, and resins cured with an active energy beam. These resins preferably have functional groups having reactivity for the crosslinking agent used (for example, functional groups such as hydroxyl, amino, carboxyl or epoxy groups).

In the receiving layer of the present invention, a chemically reacting crosslinking agent of a type which cures or polymerizes using a chemical reaction is preferable for a crosslinking agent. Examples of chemically reacting crosslinking agents include addition reaction types such as epoxy compounds and isocyanate compounds, heat curing types such as resol resins, wet curing types such as 2-cyanoacrylate and alkyl titanate, and condensation reaction types such as urea. Crosslinking agents such as isocyanate compounds and epoxy compounds are preferably used as addition reaction type crosslinking agents. The blended amount of crosslinking agent is preferably about 1 to 30% by weight as the blending ratio to the total solid content of the receiving layer.

In the receiving layer of the present invention, an anti-sticking agent, colored pigment, colored dye, fluorescent whitener, plasticizer, antioxidant, inorganic pigment or ultraviolet absorber and so forth can be added as necessary within a range that does not impair the effects of the present invention. Release agents and lubricants are used as anti-sticking agents, and examples include modified silicone oils such as amino-modified, hydroxy-modified or carboxy-modified silicone oils, non-modified silicone oils, silicone resins such as silicone acrylic resin, prepolymers of modified silicone oils and isocyanate compounds, silicone compounds, fluorine compounds, fatty acid ester compounds and phosphate compounds, and one or more types thereof can be used.

Examples of ultraviolet absorbers used include benzotriazole, benzophenone, phenyl salicylate and cyanoacrylate ultraviolet ray absorbing compounds. These various types of receiving layer additives may cause a crosslinking reaction by means of a crosslinking agent. These additives may be coated after mixing with the main component of the receiving layer, or they may be coated on and/or under the receiving layer as a separately coated layer.

The amount of solid coating component of the receiving layer is adjusted to be within the range of 1 to 12 g/m² and preferably within the range of 3 to 10 g/m². Incidentally, if the amount of solid coated component of the receiving layer is less than 1 g/m², the receiving layer is unable to completely cover the support surface, thereby resulting in a decrease in image quality, or problems with sticking between the receiving layer and ink sheet due to the heat of the thermal head. On the other hand, if the amount of the solid coating component exceeds 12 g/m², the effects are saturated, which in addition to being uneconomical, results in inadequate strength of the receiving layer or the insulation effects of the support being unable to be adequately demonstrated due to the increased thickness of the receiving layer, thereby causing a decrease in image density.

(Back Layer)

A back layer may be provided on the back of the sheet-like support (opposite side from the side on which the receiving layer is provided) in the receiving sheet of the present invention. The back layer has a resin effective as an adhesive for its main component, and may also contain a crosslinking agent, antistatic agent, anti-sticking agent, inorganic and/or organic pigment and so forth.

A resin for forming the back layer which is effective as an adhesive is used for the back layer of the present invention. This resin is effective for improving adhesive strength between the back layer and the support, for preventing damage to the receiving layer side, and for preventing transfer of dye to the back layer in contact with the receiving layer side. Examples resins that can be used include acrylic resins, epoxy resins, polyester resins, phenol resins, alkyd resins, urethane resins, melamine resins and polyvinyl acetal resins, as well as reactive cured products of these resins. In addition, a suitable aforementioned polyisocyanate compound, epoxy compound or other crosslinking agent may be blended into the back layer coating to improve adhesion between the sheet-like support and the back layer.

An antistatic agent such as a conductive resin or conductive inorganic pigment is added to the back layer of the present invention to prevent static electricity. Examples of conductive resins include cationic, anionic and nonionic resins, and specific examples of cationic conductive resins used particularly preferably include polyethyleneimines, acrylic polymers containing a cationic monomer, cation-modified acrylamide polymers and cationic starches. In addition, examples of conductive inorganic pigments include oxides and/or sulfides and other compound semiconductor pigments as well as inorganic pigments coated with the aforementioned compound semiconductor pigments.

A friction coefficient adjuster such as an organic or inorganic filler can be blended into the back layer of the present invention. Examples of organic fillers that can be used include Nylon filler, cellulose filler, urea resin filler, styrene resin filler and acrylic resin filler. Examples of inorganic fillers that can be used include silica, barium sulfate, kaolin, clay, talc, ground calcium carbonate, precipitated calcium carbonate, titanium oxide and zinc oxide.

The back layer can also contain a lubricant, release agent or other anti-sticking agent as necessary. Examples of anti-sticking agents include non-modified and modified silicone oil, silicone block copolymers, silicone rubber and other silicone compounds, phosphate ester compounds, fatty acid ester compounds and fluorine compounds. In addition, conventionally known antifoaming agents, dispersants, colored pigments, fluorescent dyes, fluorescent pigments, ultraviolet absorbers and so forth may be suitably selected and used.

The amount of solid coating component of the back layer is preferably within the range of 0.3 to 10 g/m², and more preferably 1 to 8 g/m². If the amount of solid coating component of the back layer is less than 0.3 g/m², damage prevention is not adequately demonstrated during abrasion of the receiving sheet, and areas of missing coating occur resulting in an increase in surface electrical resistance. On the other hand, if the solid coating component exceeds 10 g/m², effects are saturated thereby making this uneconomical.

In addition, the image receiving sheet of the present invention may be provided with an image protective layer which is formed after thermal transfer printing. Formation of the image protective layer may be carried out by so-called thermal transfer in which an image protective layer for transfer is provided on the ink ribbon and the image protective layer is transferred onto a thermal transfer image by heating, or formation of the image protective layer may be carried out by an adhesion method in which a substantially transparent sheet is adhered to and layered onto a thermal transfer image.

In general, single-leaf sheets or a roll is used for the receiving sheet according to the type of printer. Since ordinary receiving sheets curl towards the receiving layer due to heat from the thermal head, the present invention can be applied to both single-leaf sheets and rolls. In the case of a rolled receiving sheet, winding curl can be imparted by examining the paper tube diameter.

Each of the coating layers in the present invention, including the anchor layer, receiving layer, back layer and hollow particle-containing intermediate layer, can be applied, dried and formed using a known coater, such as a bar coater, gravure coater, comma coater, blade coater, air knife coater, gate roll coater, die coater, curtain coater, lip coater or slide bead coater.

In the present invention, calender treatment may be carried out on the receiving sheet, and surface irregularities in the surface of the receiving layer can be reduced and smoothened. Calender treatment may be carried out at any stage after coating the intermediate layer, barrier layer or receiving layer. Although there are no particular limitations on the calender device, nip pressure, number of nips, metal roller surface temperature and so forth used for calender treatment, the pressure during calender treatment is preferably 0.5 to 50 MPa and more preferably 1 to 30 MPa. The temperature is preferably from room temperature up to the temperature at which the hollow particles are not destroyed and is equal to or lower than the melting point of the binder resin for the intermediate layer, more preferably 20 to 150° C., and even more preferably 30 to 130° C. A calender device typically used in the papermaking industry can be suitably used for the calender device, examples of which include a super calender, soft calender, cross calender or clearance calender.

Moreover, prevention of curling of a rolled receiving sheet can be specifically carried out according to the following process in accordance with the printing method as claimed in a second aspect of the present invention.

(A) Winding Curl

Rolled receiving sheets have a configuration in which they are wound onto a take-up cylinder as necessary with the receiving layer on the inside. Since the receiving layer is not exposed to the outside as a result of being wound with the receiving sheet on the inside, the receiving sheet is not damaged during handling, thereby making this a preferable form. However, when rolled receiving sheets are allowed to stand for a long period of time, the curled shape formed during winding into a roll remains, and so-called winding curl is imparted to the receiving sheet. The direction of this winding curl is in the form of a top curl in which the receiving layer side becomes concave.

Furthermore, the take-up cylinder may be made of paper, plastic, metal, wood or composite materials thereof, and is a tube formed into the shape of a cylinder. Although it becomes difficult for winding curl to occur the larger the diameter of the take-up cylinder, if the outer diameter of the take-up cylinder is excessively large, since the outer diameter of the resulting rolled receiving sheet also becomes excessively large, the volume required when housing the rolled receiving sheet in the printer increases, which is disadvantageous in terms of making the printer more compact. A take-up cylinder having an outer diameter of 30 to 110 mm is preferably used for the rolled receiving sheet of the present invention, and about 10 to 100 m of the receiving sheet is wound onto this take-up cylinder. Thus, the outer diameter of the resulting rolled receiving sheet is preferably about 60 to 230 mm.

(B) Curl Correction Treatment

In a printing method as claimed in a second aspect of the present invention, printing is carried out before and/or after carrying out curl correction treatment on the receiving sheet. Curl correction treatment is carried out by applying stress to the rolled receiving sheet by contacting the surface of a decurling roller with the back of the receiving sheet (side on which the receiving layer is not provided). Namely, curling is corrected by applying stress by contacting the surface of the decurling roller with the back of the receiving sheet so that the receiving side is convex with respect to the receiving sheet to which winding curl has been imparted in the form of top curl.

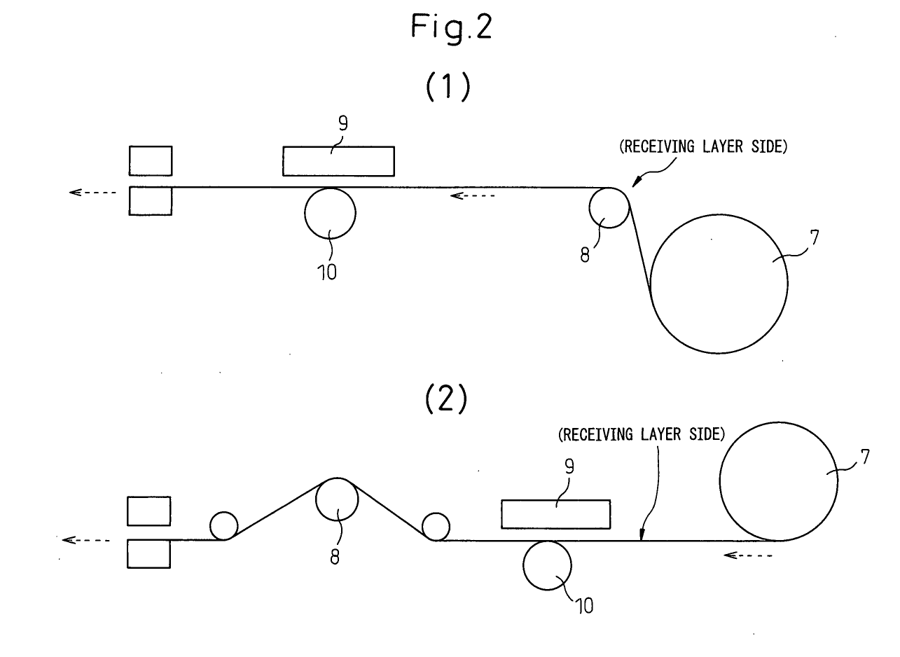

Although FIG. 2 shows a schematic drawing of a printing method using a thermal transfer printer as claimed in a second aspect of the present invention, the present invention is not limited thereto. For example, in describing the case of carrying out curl correction treatment within a thermal transfer printer, in the case of (1) printing (forming an image) after having carried out curl correction treatment, curl correction treatment can be carried out using decurling roller 8 provided between the paper feed unit of rolled receiving sheet 7 and thermal head 9 or platen roller 10 within the printer.

In addition, in the case of (2) printing before carrying out curl correction treatment (namely, carrying out curl correction treatment after printing), curl correction treatment can be carried out on the receiving sheet 7 using decurling roller 8 provided on the discharge side of the thermal head 9 of the printer. Curl correction treatment can naturally be carried out before or after printing. In addition, curl correction treatment may be carried out using a separate curl correction treatment device from the thermal transfer printer.

More specifically, the diameter of the decurling roller is preferably 30 mm or less, and more preferably 5 to 25 mm. If the diameter of the decurling roller exceeds 30 mm, curl correction effects are lacking, thereby making this undesirable. In addition, the winding angle between the decurling roller and the receiving sheet (the angle connecting each tangent point of the receiving sheet and decurling roller with the center of the decurling roller, also referred to as the holding angle) is preferably 20 to 180°, and more preferably 30 to 180°. If the winding angle of the receiving sheet is less than 20°, curl correction effects are lacking, thereby making this undesirable. In addition, if the winding angle of the receiving sheet exceeds 180°, the configuration of the paper feeding path becomes complex and curl correction effects decrease, thereby making this undesirable.

There are no particular limitations on the material of the decurling roller, and a metal roller is used typically. In addition, preventing the decurling roller from rotating while stopped makes it possible to effectively correct curling of the receiving sheet. Curl correction treatment is achieved by applying a powerful external force (stress) to the receiving sheet with strong tension, such as by passing over a decurling roller composed in the manner described above.

For example, in the case of printing after carrying out curl correction treatment, the receiving sheet held within the thermal transfer printer is unrolled, and after carrying out curl correction treatment on this receiving sheet, although printing is carried out using the thermal head, there are no particular limitations on the number of times curl correction treatment is carried out. In a thermal transfer color recording and printing system, although color images are usually formed by repeating printing three times each for the colors yellow, magenta and cyan (and black and/or overcoating can be added depending on the case), curl correction treatment can be carried out repeatedly several times for the printing of each color.

(C) Curl After Printing

When the receiving layer side of a receiving sheet is printed using a thermal transfer printer, since the receiving layer side is heated by heat from the thermal head being selectively applied thereto, the receiving layer side shrinks more than the back side, and curling of the receiving sheet shifts in the direction of top curl.

In the printing method as claimed in a second aspect of the present invention, in the case of, for example, printing after having carried out curl correction treatment, back curl is imparted to the receiving sheet as a result of carrying out curl correction treatment on the receiving sheet to which a top curl has been imparted as previously described. Since curling of this receiving sheet imparted with back curl prior to printing shifts in the direction of top curl as a result of printing, a receiving sheet imparted with a suitable degree of back curl immediately before printing can be obtained in a satisfactory form in which curling of the receiving sheet after printing is nearly flat.

Namely, if the back curl imparted in curl correction treatment is excessively large, although curling of the receiving sheet shifts in the direction of top curl due to the heat during printing, a large amount of back curl remains in the curling of the receiving sheet after printing, which is undesirable. In addition, if the back curl imparted in curl correction treatment is excessively small, although curling of the receiving sheet shifts in the direction of top curl as a result of printing, a large top curl still remains in the curling of the receiving sheet after printing, which is also undesirable.

In addition, the same is true for the case of carrying out printing before curl correction treatment (namely, carrying out curl correction treatment after printing) in that when a receiving sheet imparted with top curl due to winding curl is printed using a thermal head, the curling of the receiving sheet shifts in the direction of an even larger top curl. A receiving sheet can be obtained in a satisfactory form in which curling of the receiving sheet after printing is nearly flat by carrying out curl correction treatment as described above on this receiving sheet.

Although the following provides a detailed explanation of the present invention through the following examples, the scope of the present invention is not limited by these examples. Furthermore, the terms “%” and “parts” in the examples refer to the “% by weight” and “parts by weight” of the solid content, except in cases when referring to a solvent, unless specifically indicated otherwise.

### EXAMPLE 1

(Formation of Support)

A support was obtained by using for the core material a porous, multilayer-structured, uniaxially or biaxially oriented polyolefin film having polypropylene for its main component, containing an inorganic pigment in the form of calcium carbonate, and having a thickness of 110 μm (trade name: Yupo FPG110, Yupo Corp.), and dry laminating a biaxially oriented porous multilayer-structured polyester film having polyethylene terephthalate for its main component and a thickness of 50 μm (trade name: E63S, Toray, thermal shrinkage: 0.04%) on both sides thereof using a urethane adhesive.

(Formation of Back Layer)

A back layer coating liquid 1 having the composition indicated below was coated onto one side of the aforementioned support to an amount of coated solid of 3 g/m2 and dried to form a back layer.

| Back Layer Coating Liquid 1 | |
|---|---|
| Polyvinyl acetal resin: (trade name: | 35 parts |
| S-LEC KX-1, Sekisui Chemical), | |
| Polyacrylate resin (trade name: Jurymer | 25 parts |
| AT613, Nihon Junyaku) | |
| Nylon resin particles (trade name: | 10 parts |
| MW330, Shinto Paint) | |
| Zinc stearate (trade name: Z-7-30, | 20 parts |
| Chukyo Yushi) | |
| Cationic conductive resin (trade name: | 10 parts |
| Chemistat 9800, Sanyo Chemical Industries) | |
| Water/isopropyl alcohol = 2/3 (weight | 400 parts |
| ratio) mixed liquid | |
| (Formation of Anchor Layer) | |

An anchor layer coating liquid 1 having the composition indicated below was coated onto the porous multilayer-structured polyester film side of the support to serve as the receiving layer side thereof to an amount of coated solid of 1 g/m² and dried to form an anchor layer.

| Anchor Layer Coating Liquid 1 | |
|---|---|
| Acrylate resin (trade name: SAR615A, | 50 parts |
| Chuo Rika Kogyo) | |
| Cationic conductive resin (trade name: | 50 parts |
| Chemistat 9800, Sanyo Chemical Industries) | |
| Water/isopropyl alcohol = 4/6 (weight | 400 parts |
| ratio) mixed liquid | |
| (Formation of Receiving Layer) | |

Next, a receiving layer coating liquid 1 having the following composition was coated onto the aforementioned anchor layer to an amount of coated solid of 5 g/m² and dried to form a receiving layer.

| Receiving Layer Coating Liquid 1 | |
|---|---|
| Polyester resin (trade name: Vylon 200, | 100 parts |
| Toyobo) | |
| Silicone oil (trade name: KF101, | 3 parts |
| Shin-Etsu Chemical) | |
| Polyisocyanate (trade name: Takenate | 5 parts |
| D-140N, Mitsui-Takeda Chemicals) | |
| Toluene/methyl ethyl ketone = 1/1 | 300 parts |
| (weight ratio) mixed liquid | |

Moreover, in a process in which the receiving sheet following drying of the receiving layer was subjected to heat treatment followed by crosslinking the receiving layer, the receiving sheet was wound into the shape of a roll onto a winding core having an outer diameter of 170 mm so that the receiving layer coated surface was on the inside of the roll, followed immediately by carrying out crosslinking of the receiving layer by placing in a moisture-proof pouch and allowing to stand for 5 days in a heat treatment chamber controlled to a temperature of 50° C. and relative humidity of 30%.

(Appearance of Curling of Receiving Sheet Before Printing)

The finished receiving sheet was cut to A6 size so as to align the direction of roll flow with the lengthwise direction after cutting. Curling of the receiving sheet before printing was flat, and the total thickness of the receiving sheet was 230 μm.

(Curl Height of Receiving Sheet After Printing)

A thermal transfer printer was fabricated to allow replacement of the platen roller in which the angle between the tangential direction at the location contacted by the thermal head on the platen roller and the direction of transport (to be referred to as the winding angle) can be adjusted according to the location of the transport roller. After adjusting the winding angle to 3° (L/R=0.010) using a platen roller having a radius of 22 mm, black solid images were printed with the three colors of yellow, magenta and cyan so that the lengthwise direction was the direction of transport onto the aforementioned A6 size receiving sheet using an ink ribbon provided with an ink layer containing each of yellow, magenta and cyan sublimation dyes and a binder on a polyester film having a thickness of 6 μm, followed by carrying out overcoating treatment. A commercially available SVM-25LS ink ribbon manufactured by Sony Corp. was used for the ink ribbon, and the images were printed after adjusting the printing energy to a printing density of 2.0 using a Macbeth reflection densitometer RD-914 (Gretag Macbeth).

After printing, the receiving sheet was allowed to stand for 5 minutes on a horizontal surface at 23° C. and 50% RH with the receiving layer side either up or down, the maximum height of the four corners of the receiving sheet were measured, and the maximum height was indicated in the tables as the amount of curl after printing.

### EXAMPLE 2

Curl after printing was measured in the same manner as Example 1 with the exception of changing the diameter of the platen roller to 5.5 mm (L/R=0.042).

### EXAMPLE 3

Curl after printing was measured in the same manner as Example 1 with the exception of adjusting the winding angle to 12°.

### EXAMPLE 4

Curl after printing was measured in the sample manner as Example 3 with the exception of changing the diameter of the platen roller to 5.5 mm (L/R=0.042).

### EXAMPLE 5

Curl after printing was measured in the same manner as Example 1 with the exception of adjusting the winding angle to 20°.

### EXAMPLE 6

Curl after printing was measured in the same manner as Example 5 with the exception of changing the diameter of the platen roller to 5.5 mm (L/R=0.042).

### EXAMPLE 7

A rolled receiving sheet was produced in the same manner as Example 2 with the exception of changing the core material layer of the support in the manner indicated below, followed by measurement of curl after printing.

(Support Core Material Layer)

Coated paper having a thickness of 100 μm (trade name: OK TopCoat 127.9 g/m², Oji Paper Co., Ltd.) was used for the core layer material.

The thickness of the resulting receiving sheet was 220 μm (L/R=0.040).

### EXAMPLE 8

A receiving sheet was produced in the same manner as Example 1 followed by measurement of curl after printing with the exception of producing a support by using for the core material layer a porous, multilayer-structured, uniaxially or biaxially oriented polyolefin film having polypropylene for its main component, containing an inorganic pigment in the form of calcium carbonate, and having a thickness of 110 μm (trade name: Yupo FPG110, Yupo Corp.), and dry laminating a biaxially oriented, porous multilayer-structured polyester film having polyethylene terephthalate for its main component and a thickness of 50 μm (trade name: E20, Toray, thermal shrinkage: 0.2%) on both sides thereof using a urethane adhesive.

### EXAMPLE 9

A biaxially oriented, porous multilayer-structured film having polypropylene for its main component and a thickness of 50 μm (trade name: FPG50, Yupo Corp.) was heat-treated for 24 hours at 90° C. in a rolled state to bring the thermal shrinkage to 0.8%. Curl after printing was then measured in the same manner as Example 1 with the exception of obtaining a support by dry laminating this film on both sides of a core material in the form of a biaxially oriented film having polyethylene terephthalate for its main component and a thickness of 100 μm (trade name: 100S10, Toray, thermal shrinkage: 0.5%) using a urethane adhesive.

### COMPARATIVE EXAMPLE 1

Curl after printing was measured in the same manner as Example 1 with the exception of adjusting the winding angle to 1°.

### COMPARATIVE EXAMPLE 2

Curl after printing was measured in the same manner as Example 2 with the exception of adjusting the winding angle to 1°.

### COMPARATIVE EXAMPLE 3

Curl after printing was measured in the same manner as Example 1 with the exception of adjusting the winding angle to 30°.

### COMPARATIVE EXAMPLE 4

Curl after printing was measured in the same manner as Example 2 with the exception of adjusting the winding angle to 30°.

### COMPARATIVE EXAMPLE 5

Curl after printing was measured in the same manner as Example 3 with the exception of changing the diameter of the platen roller to 30 mm (L/R=0.008).

### EXAMPLE 10

(Formation of Hollow Particle-Containing Intermediate Layer)

High-quality paper having a thickness of 127 μm (trade name: OK Prince High Quality, 104.7 g/m², Oji Paper Co., Ltd.) was used for the sheet-like support, a hollow particle-containing intermediate layer coating liquid 1 having the composition indicated below was coated onto one side thereof to a film thickness of 50 μm after drying, followed by drying to form a hollow particle-containing intermediate layer and carrying out calender treatment for smoothing the surface (roller surface temperature: 80° C., nip pressure: 2.5 MPa).

| Hollow Particle-Containing Intermediate Layer | |
|---|---|
| Coating Liquid 1 | |
| Polyvinylidene chloride foam hollow | 35 parts |
| particles (volumetric hollow ratio: 93%, | |
| mean particle diameter: 4 μm, maximum | |
| particle diameter: 20 μm) | |
| Polyvinyl alcohol (PVA205, Kuraray) | 15 parts |
| Styrene-butadiene latex (trade name: | 50 parts |
| PT1004, Zeon Corp.) | |
| Water | 200 parts |
| (Production of Receiving Sheet) | |

A barrier layer coating liquid 1 having the composition indicated below was further coated onto the aforementioned hollow particle-containing intermediate layer to an amount of coated solid of 2 g/m² followed by drying to form a barrier layer. The receiving layer coating liquid 1 of Example 1 was then coated onto this barrier layer to an amount of coated solid of 5 g/m² followed by drying and curing for 48 hours at 50° C. to form a receiving layer and produce the receiving sheet.

Moreover, after forming the receiving layer, molding treatment was carried out by pressing the receiving layer side against a metal roller at a temperature of 78° C. and having a surface roughness (Ra) of 0.03 μm at a pressure of 10 MPa. The thickness of the receiving sheet was 180 μm.

| Barrier Layer Coating Liquid 1 | |
|---|---|
| Polyvinyl alcohol (trade name: PVA117, | 100 parts |
| Kuraray) | |
| Water | 1000 parts |
| (Measurement of Curl After Printing) | |

Curl was measured in the same manner as Example 1 using a platen roller having a radius of 15 mm (L/R=0.012) and adjusting the winding angle to 3°.

### EXAMPLE 11

Curl after printing was measured in the same manner as Example 10 with the exception of adjusting the winding angle to 20°.

### EXAMPLE 12

Curl after printing was measured in the same manner as Example 10 with the exception of changing to platen roller having a radius of 5 mm (L/R=0.036).

### EXAMPLE 13

Curl after printing was measured in the same manner as Example 10 with the exception of using a platen roller having a radium of 5 mm (L/R=0.036) and adjusting the winding angle to 20°.

### EXAMPLE 14

A receiving sheet was produced in the same manner as Example 10 with the exception of using high-quality paper having a thickness of 203 μm for the sheet-like support (trade name: OK Prince High-Quality Eco G100, 157.0 g/m², Oji Paper Co., Ltd.). The thickness of the receiving sheet was 255 μm.

(Measurement of Curl After Printing)

Curl was measured in the same manner as Example 1 with the exception of using a platen roller having a radius of 15 mm (L/R=0.017) and adjusting the winding angle to 3°.

### EXAMPLE 15

Curl after printing was measured in the same manner as Example 14 with the exception of adjusting the winding angle to 20°.

### EXAMPLE 16

Curl after printing was measured in the same manner as Example 14 with the exception of changing to a platen roller having a radius of 5 mm (L/R=0.051).

### EXAMPLE 17

Curl after printing was measured in the same manner as Example 14 with the exception of changing to a platen roller having a radius of 5 mm (L/R=0.051) and adjusting the winding angle to 20°.

### COMPARATIVE EXAMPLE 6

Curl after printing was measured in the same manner as Example 10 with the exception of changing to a platen roller having a radius of 25 mm (L/R=0.007).

### COMPARATIVE EXAMPLE 7

Curl after printing was measured in the same manner as Example 10 with the exception of using a platen roller having a radius of 5 mm (L/R=0.036) and adjusting the winding angle to 30°.

Evaluation

The receiving sheets obtained in each of the examples and comparative examples were evaluated in the manner described below, and those results are summarized in Table 1 (Examples 1-9 and Comparative Examples 1-5) and Table 2 (Examples 10-17 and Comparative Examples 6 and 7).

(Measurement of Receiving Sheet Thermal Shrinkage)

Measurement of thermal shrinkage was carried out in compliance with JIS C2151. Each receiving sheet was cut out to 100 mm or more in the direction of printing followed by measurement of the length of the receiving sheet in the direction of printing using a Quick Scope (Mitutoyo Corp.). After heating the receiving sheet for 30 minutes by placing in a circulating hot air dryer heated to 100° C. and cooling for 1 hour at room temperature, the length in the direction of printing of the receiving sheet was measured in the same manner as that before heating. Thermal shrinkage was calculated from the lengths before and after heating of the receiving sheet using the equation shown below.

$$Thermal shrinkage ( \% ) = \frac{( length before heating - length after heating )}{( length before heating )} \times 100$$

(Evaluation of Curl After Printing)

After allowing each printed receiving sheet (A6 size, width: 105 mm, length: 148 mm) to stand for 5 minutes each on a horizontal surface at a temperature of 23° C. and 50% RH with the receiving layer side facing up and then facing down, the maximum heights of the four corners of the receiving sheet were measured, and the maximum height was used as the curl after printing.

Curl after printing was evaluated using the following criteria. Furthermore, the receiving sheet was judged to be able to be used practically if the result of the evaluation was superior or good.

Superior: Back curl or top curl of 0 to 5 mm

Good: Back curl or top curl of more than 5 mm to 10 mm

Poor: Back curl or top curl of more than 10 mm

(Measurement of Receiving Sheet Rigidity)

The rigidity of each receiving sheet was measured by measuring the Gurley stiffness in the direction of printing of the receiving sheet using the Gurley Stiffness Measuring Instrument manufactured by Toyobo Co., Ltd. Based on TAPPI T543 84.

TABLE 1

| | | | | | Receiving | Curl | |
|---|---|---|---|---|---|---|---|
| | Receiving | Platen | | | sheet | height | |
| | sheet | roller | | Winding | thermal | after | Curl |
| | thickness | radius | L/R | angle | shrinkage | printing | evalu- |
| | (μm) | R (mm) | (ratio) | (°) | (%) | (mm) | ation |
| Ex. 1 | 230 | 22.0 | 0.010 | 3 | 0.4 | Top 8 | Good |
| Ex. 2 | 230 | 5.5 | 0.042 | 3 | 0.4 | Top 6 | Good |
| Ex. 3 | 230 | 22.0 | 0.010 | 12 | 0.4 | Top 3 | Superior |
| Ex. 4 | 230 | 5.5 | 0.042 | 12 | 0.4 | Back 2 | Superior |
| Ex. 5 | 230 | 22.0 | 0.010 | 20 | 0.4 | Back 5 | Superior |
| Ex. 6 | 230 | 5.5 | 0.042 | 20 | 0.4 | Back 8 | Good |
| Ex. 7 | 220 | 5.5 | 0.040 | 3 | 0.05 | Top 7 | Good |
| Ex. 8 | 230 | 22.0 | 0.010 | 3 | 0.2 | Top 5 | Superior |
| Ex. 9 | 220 | 22.0 | 0.010 | 3 | 0.7 | Top 9 | Good |
| Comp. | 230 | 22.0 | 0.010 | 1 | 0.4 | Top 13 | Inferior |
| Ex. 1 | | | | | | | |
| Comp. | 230 | 5.5 | 0.042 | 1 | 0.4 | Top 11 | Inferior |
| Ex. 2 | | | | | | | |
| Comp. | 230 | 22.0 | 0.010 | 30 | 0.4 | Back 13 | Inferior |
| Ex. 3 | | | | | | | |
| Comp. | 230 | 5.5 | 0.042 | 30 | 0.4 | Back 16 | Inferior |
| Ex. 4 | | | | | | | |
| Comp. | 230 | 30.0 | 0.008 | 12 | 0.4 | Top 11 | Inferior |
| Ex. 5 | | | | | | | |

TABLE 2

| | Receiv- | | | | | | | Curl | |
|---|---|---|---|---|---|---|---|---|---|
| | ing | | | | | | | height | |
| | sheet | Support | W/L | | Platen | | Wind- | after | Curl |
| | thick- | thick- | x | Rigid- | roller | | ing | print- | evalu- |
| | ness L | ness W | 100 | ity | radius | L/R | angle | ing | ation |
| | (μm) | (μm) | (%) | (SGU) | R (mm) | (ratio) | (°) | (mm) | |
| Ex. 10 | 180 | 127 | 70.6 | 700 | 15 | 0.012 | 3 | Top 4 | Superior |
| Ex. 11 | 180 | 127 | 70.6 | 700 | 15 | 0.012 | 20 | Top 2 | Superior |
| Ex. 12 | 180 | 127 | 70.6 | 700 | 5 | 0.036 | 3 | Top 3 | Superior |
| Ex. 13 | 180 | 127 | 70.6 | 700 | 5 | 0.036 | 20 | Back 4 | Superior |
| Ex. 14 | 255 | 203 | 79.6 | 1700 | 15 | 0.017 | 3 | Top 8 | Good |
| Ex. 15 | 255 | 203 | 79.6 | 1700 | 15 | 0.017 | 20 | Back 2 | Superior |
| Ex. 16 | 255 | 203 | 79.6 | 1700 | 5 | 0.051 | 3 | Top 2 | Superior |
| Ex. 17 | 255 | 203 | 79.6 | 1700 | 5 | 0.051 | 20 | Back 5 | Superior |
| Comp. | 180 | 127 | 70.6 | 700 | 25 | 0.007 | 3 | Top 11 | Inferior |
| Ex. 6 | | | | | | | | | |
| Comp. | 180 | 127 | 70.6 | 700 | 5 | 0.036 | 30 | Back 11 | Inferior |
| Ex. 7 | | | | | | | | | |

Based on the results of Table 1, the receiving sheets obtained in each of the examples of the present invention were confirmed to have favorable curl after printing. On the other hand, the receiving sheets of Comparative Examples 1, 2 and 5 were determined to have excessive top curl after printing, while the receiving sheets of Comparative Examples 3 and 4 were determined to have excessive back curl after printing.

In addition, based on the results of Table 2, the receiving sheets obtained in each of the examples of the present invention were confirmed to have favorable curl after printing. On the other hand, the receiving sheet of Comparative Example 6 was determined to have excessive top curl after printing, while the receiving sheet of Comparative Example 7 was determined to have excessive back curl after printing.

### EXAMPLE 18

(Formation of Intermediate Layer)

Art paper having a thickness of 150 μm (trade name: OK Kanefuji N, 174.4 g/m 2, Oji Paper Co., Ltd.) was used for the sheet-like support, and a hollow particle-containing intermediate layer coating liquid 2 having the composition indicated below was coated onto one side thereof to a film thickness after drying of 51 μm followed by drying to form an intermediate layer.

| Hollow Particle-Containing Intermediate Layer | |
|---|---|
| Coating Liquid 2 | |
| Volatile foam hollow particles composed | 45 parts |
| of copolymer primarily consisting of | |
| acrylonitrile and methacrylonitrile (mean | |
| particle diameter: 3.2 μm, volumetric | |
| hollow ratio: 76%) | |
| Polyvinyl alcohol (trade name: PVA205, | 10 parts |
| Kuraray) | |
| Styrene-butadiene latex (trade name: | 45 parts |
| PT1004, Zeon Corp.) | |
| Water | 250 parts |
| (Formation of Barrier Layer and Receiving Layer) | |

A barrier layer coating liquid 2 having the composition indicated below was coated onto the aforementioned intermediate layer to an amount of coated solid of 2 g/m² followed by drying to form a barrier layer, and a receiving layer coating liquid 2 having the composition indicated below was coated onto the barrier layer to an amount of coated solid of 5 g/m² followed by drying to form a receiving layer.

| Barrier Layer Coating Liquid 2 | |
|---|---|
| Swelling inorganic layered compound | 30 parts |
| (sodium tetrasilic mica, particle mean | |
| diameter: 6.3 μm, aspect ratio: 2700) | |
| Polyvinyl alcohol (trade name: PVA105, | 50 parts |
| Kuraray) | |
| Styrene-butadiene latex (trade name: | 20 parts |
| L-1537, Asahi Kasei) | |
| Water | 1100 parts |

| Receiving Layer Coating Liquid 2 | |
|---|---|
| Polyester resin (trade name: Vylon 200, | 100 parts |
| Toyobo) | |
| Silicone oil (trade name: KF393, | 3 parts |
| Shin-Etsu Chemical) | |
| Polyisocyanate (trade name: Takenate | 5 parts |
| D-140N, Mitsui-Takeda Chemicals) | |
| Toluene/methyl ethyl ketone = 1/1 | 400 parts |
| (weight ratio) mixed liquid | |
| (Production of Receiving Sheet) | |

Next, a back layer coating liquid 2 having the composition indicated below was coated onto the opposite side of the side on which the receiving layer is provided of the sheet-like support to an amount of coated solid after drying of 3 g/m² followed by drying to form a back layer and subsequently aging for 48 hours at 50° C. Moreover, a receiving sheet was produced by carrying out calender treatment (roller surface temperature: 78° C., nip pressure: 2.5 MPa) to smoothen the surface of the receiving sheet.

| Back Layer Coating Liquid 2 | |
|---|---|
| Polyvinyl acetal resin: (trade name: | 40 parts |
| S-LEC KX-1, Sekisui Chemical), | |
| Polyacrylate resin (trade name: Juryimer | 20 parts |
| AT613, Nihon Junyaku) | |
| Nylon resin particles (trade name: | 10 parts |
| MW330, Shinto Paint) | |
| Zinc stearate (trade name: Z-7-30, | 10 parts |
| Chukyo Yushi) | |
| Cationic conductive resin (trade name: | 20 parts |
| Chemistat 9800, Sanyo Chemical Industries) | |
| Water/isopropyl alcohol = 2/3 (weight | 400 parts |
| ratio) mixed liquid | |
| (Production of Rolled Receiving Sheet) | |

The receiving sheet obtained in the manner described above was supplied to a slitter, small roll slits were made in the receiving sheet, and the receiving sheet was wound into a small roll having a width of 127 mm and wound length of 80 m to obtain a rolled receiving sheet. Furthermore, the rolled receiving sheet was wound onto a small roll take-up cylinder with the coated surface of the receiving layer on the inside of the roll. A cushioned paper cylinder (take-up cylinder outer diameter: 60 mm) having an inner diameter of 2 inches was used for the small roll take-up cylinder. In addition, the outer diameter of the resulting rolled receiving sheet was 160 mm.

(Image Formation)

A thermal transfer printer was fabricated which allowed the winding angle of the rolled receiving sheet onto a decurling roller to be variably adjusted by varying the location of the unwinding paper feed unit of the rolled receiving sheet. Furthermore, a decurling roller having an outer diameter of 20 mm was installed between the rolled receiving sheet unwinding paper feed unit and the thermal head of the printer. In addition, an ink ribbon was prepared provided with an ink layer containing sublimation dyes in the three colors of yellow, magenta and cyan along with a binder on a polyester film having a thickness of 6 μm.

The rolled receiving sheet wound with the receiving layer obtained in the manner described above on the inside was unwound from the unwinding paper feed unit, adjusted so that the winding angle of the rolled receiving sheet to the decurling roller was 60°, and the surface of the decurling roller was made to contact the back layer side of the rolled receiving sheet to carry out curl correction treatment. Continuing, each color of ink layer of the ink ribbon was sequentially contacted with the receiving sheet and controlled heat was applied in a stepwise manner with the thermal head to cause thermal transfer of a predetermined image to the receiving sheet, thereby resulting in printing of half-tone monochromatic and multi-color images of each color. Following printing, the receiving sheet was cut to a length in the direction of transport of 179 mm with a cutter, after which the receiving sheet was discharged to a paper tray.

### EXAMPLE 19

Image formation was carried out in the same manner as Example 18 with the exception of using a roller having an outer diameter of 10 mm for the decurling roller in the image formation step of Example 18.

### EXAMPLE 20

Image formation was carried out in the same manner as Example 18 with the exception of using a roller having an outer diameter of 30 mm for the decurling roller in the image formation step of Example 18.

### EXAMPLE 21

Image formation was carried out in the same manner as Example 18 with the exception of adjusting the winding angle of the rolled receiving sheet to the decurling roller to 30° in the image formation step of Example 18.

### EXAMPLE 22

Image formation was carried out in the same manner as Example 18 with the exception of adjusting the winding angle of the rolled receiving sheet to the decurling roller was 150° in the image formation step of Example 18.

### EXAMPLE 23

Image formation was carried out in the same manner as Example 18 with the exception of adjusting the winding angle of the rolled receiving sheet to the decurling roller to 30°, and carrying out curl correction treatment a total of three times before printing of each color of yellow, magenta and cyan in the image formation step of Example 18.

### EXAMPLE 24

Image formation was carried out in the same manner as Example 18 with the exception of changing the formation of a rolled receiving sheet step of Example 18 as indicated below.

(Production of Rolled Receiving Sheet)

The receiving sheet obtained in the manner described above was supplied to a slitter, small roll slits were made in the receiving sheet, and a small roll was produced having a width of 127 mm and wound length of 50 m to obtain a rolled receiving sheet. Furthermore, the rolled receiving sheet was wound onto a small roll take-up cylinder with the coated surface of the receiving layer on the inside of the roll. A cushioned paper cylinder (take-up cylinder outer diameter: 85 mm) having an inner diameter of 3 inches was used for the small roll take-up cylinder. In addition, the outer diameter of the resulting rolled receiving sheet was 145 mm.

### EXAMPLE 25

Image formation was carried out in the same manner as Example 18 with the exception of changing the image formation step of Example 18 as indicated below.

(Image Formation)

A thermal transfer printer was fabricated which allowed the winding angle of the rolled receiving sheet after printing onto the decurling roller to be variably adjusted by varying the location of the roller in the paper pathway on the output side of the thermal printer thermal head, while also allowing replacement of the decurling roller with that of a different outer diameter. Furthermore, a decurling roller having an outer diameter of 20 mm was installed between the output side of the thermal head and a paper cutter. In addition, an ink ribbon was prepared provided with an ink layer containing sublimation dyes in the three colors of yellow, magenta and cyan along with a binder on a polyester film having a thickness of 6 μm.

Next, each color of ink layer of the ink ribbon was sequentially contacted with the receiving sheet wound with the receiving layer side on the inside, and controlled heat was applied in a stepwise manner with the thermal head to cause thermal transfer of a predetermined image to the receiving sheet, thereby resulting in printing of half-tone monochromatic and multi-color images of each color. Next, curl correction treatment was carried out by adjusting the winding angle of the printed rolled receiving sheet to the decurling roller to 60°, and contacting the back layer side of the printed rolled receiving sheet with the surface of the decurling roller. Following curl correction treatment, the receiving sheet was cut to a length in the direction of transport of 179 mm with a cutter, after which the receiving sheet was discharged to a paper tray.

Evaluation

The receiving sheets obtained in each of the examples and comparative examples were evaluated in the manner described below for each of the following parameters. The evaluation results are summarized in Table 1.

(Measurement of Curl After Printing)

After printing, the receiving sheet (width: 127 mm, length: 179 mm) was allowed to stand for 5 minutes on a horizontal surface at 23° C. and 50% RH with the receiving layer side either up or down, the maximum height of the four corners of the receiving sheet were measured, and the maximum height was taken to be the amount of curl after printing.

(Discharge of Printed Receiving Sheet)

The images formed in each of the examples and comparative examples were repeatedly printed consecutively 20 times each followed by examination of the discharge of the receiving sheet into the paper tray and evaluating according to the criteria indicated below.
Superior: Printed receiving sheet was properly discharged into the paper tray.

Inferior: Printed receiving sheet protruded from the paper tray resulting in problems in paper discharge.

TABLE 3

| | Rolled | | | | | | | | |
|---|---|---|---|---|---|---|---|---|---|
| | receiving | | | | | | | | |
| | paper | | | | | | | | |
| | | Take- | | | | | | | |
| | | up | | | | | | | |
| | | cylin- | Curl Correction | | | | | | |
| | Roll | der | | Roller | Wind- | | Curl | | |
| | diam- | diam- | | diam- | ing | No. | height | Curl | |
| | eter | eter | Loca- | eter | angle | of | after | evalu- | Paper |
| | (mm) | (mm) | tion | (mm) | (°) | times | printing | ation | discharge |
| Ex. | 160 | 60 | Before | 20 | 60 | 1 | Top 2 | Superior | Superior |
| 18 | | | printing | | | | | | |
| Ex. | 160 | 60 | Before | 10 | 60 | 1 | Back 3 | Superior | Superior |
| 19 | | | printing | | | | | | |
| Ex. | 160 | 60 | Before | 30 | 60 | 1 | Top 5 | Superior | Superior |
| 20 | | | printing | | | | | | |
| Ex. | 160 | 60 | Before | 20 | 30 | 1 | Top 8 | Good | Superior |
| 21 | | | printing | | | | | | |
| Ex. | 160 | 60 | Before | 20 | 150 | 1 | Back 7 | Good | Superior |
| 22 | | | printing | | | | | | |
| Ex. | 160 | 60 | Before | 20 | 30 | 3 | Top 3 | Superior | Superior |
| 23 | | | printing | | | | | | |
| Ex. | 145 | 85 | Before | 20 | 60 | 1 | Flat | Superior | Superior |
| 24 | | | printing | | | | | | |
| Ex. | 160 | 60 | After | 20 | 60 | 1 | Top 2 | Superior | Superior |
| 25 | | | printing | | | | | | |

Based on the results of Table 3, the receiving sheet obtained in each of the examples of the present invention were confirmed to have good curl after printing, superior appearance and good printing quality.

### INDUSTRIAL APPLICABILITY

According to the thermal transfer printing method of the present invention, the amount of curl of a receiving sheet after printing can be made to be small, and printing quality having a superior appearance can be obtained. The present invention can be applied to various types of thermal printers, including not only dye thermal transfer printers but also molten ink thermal transfer types, thereby giving the present invention extremely high practical value.

1. A printing method for a thermal transfer receiving sheet in which an image is formed on an image transfer layer of the receiving sheet by superimposing the receiving sheet onto a dye thermal transfer sheet and applying thereto heat from a thermal head of a thermal transfer printer; wherein, the thermal transfer printer has a thermal head and a platen roller in opposition thereto, and the following requirements (1) and (2) are satisfied simultaneously:
(1) the ratio (L/R) of the length of the entire thermal transfer receiving sheet (L) to the radius (R) of the platen roller of the printer is 0.01 to 0.07; and,
(2) after a thermal transfer image has been formed on the image receiving layer by the thermal head, the thermal transfer receiving sheet is transported by the back side thereof being wound onto the surface of the platen roller, and the winding angle is 2 to 25°.

2. The printing method for a thermal transfer receiving sheet according to claim 1, wherein the thermal shrinkage of the thermal transfer receiving sheet at 100° C. as determined according to JIS C2151 is 0.05 to 1.0%.

3. The printing method for a thermal transfer receiving sheet according to claim 2, wherein the thermal transfer receiving sheet is provided with the image receiving layer on at least one side of a sheet-like support having a laminated structure consisting of at least three layers in which a thermoplastic resin film containing a porous structure is laminated on both sides of a core material layer.

4. The printing method for a thermal transfer receiving sheet according to claim 3, wherein the thermal shrinkage at 100° C. of the thermoplastic resin film on the side on which the image receiving layer is formed as determined according to JIS C2151 is 0.05 to 1.0%.

5. The printing method for a thermal transfer receiving sheet according to claim 1, wherein the thermal transfer receiving sheet is a thermal transfer receiving sheet in which an intermediate layer containing hollow particles and the image receiving layer are sequentially formed on at least one side of a paper base material, the thickness of the entire thermal transfer receiving sheet is 100 to 300 mm, and the ratio (%) of the thickness of the paper material to the thickness of the entire thermal transfer receiving sheet is 70 to 85%.

6. The printing method for a thermal transfer receiving sheet according to claim 5, wherein the Gurley stiffness of the thermal transfer receiving sheet in the direction in which paper is fed to the printer as defined in TAPPI TR543 84 is 500 to 2000 SGU.

7. A printing method for a thermal transfer receiving sheet in which an image is formed on an image receiving layer of the receiving sheet by superimposing the receiving sheet onto a dye thermal transfer sheet and applying thereto heat from a thermal head of a thermal transfer printer; wherein, the thermal transfer receiving sheet is a rolled thermal transfer receiving sheet wound with the image receiving layer on the inside, and curl correction treatment is carried out before forming an image and/or after having formed an image on the thermal transfer receiving sheet.

8. The printing method for a thermal transfer receiving sheet according to claim 7, wherein the curl correction treatment is carried out by contacting the surface of a decurling roller with the back of the thermal transfer receiving sheet (side not provided with an image receiving layer), and applying stress to the thermal transfer receiving sheet.

9. The printing method for a thermal transfer receiving sheet according to claim 8, wherein at least one of the decurling rollers has a diameter of 30 mm or less, and the winding angle of the thermal transfer receiving sheet which contacts the decurling roller is 20 to 180°.

10. The printing method for a thermal transfer receiving sheet according to claim 9, wherein the thermal transfer receiving sheet is wound onto a take-up roller having an outer diameter of 30 to 110 mm, and the outer diameter of the rolled thermal transfer receiving sheet is 60 to 230 mm.

11. The printing method for a thermal transfer receiving sheet according to claim 10, wherein the thermal transfer receiving sheet has an intermediate layer containing hollow particles and the image receiving layer sequentially provided on at least one side of a sheet-like support having cellulose pulp as its main component.

12. The printing method for a thermal transfer receiving sheet according to claim 7, wherein the thermal transfer receiving sheet is wound onto a take-up roller having an outer diameter of 30 to 1 10 mm, and the outer diameter of the rolled thermal transfer receiving sheet is 60 to 230 mm.

13. The printing method for a thermal transfer receiving sheet according to claim 12, wherein the thermal transfer receiving sheet has an intermediate layer containing hollow particles and the image receiving layer sequentially provided on at least one side of a sheet-like support having cellulose pulp as its main component.

14. The printing method for a thermal transfer receiving sheet according to claim 8, wherein the thermal transfer receiving sheet is wound onto a take-up roller having an outer diameter of 30 to 1 10 mm, and the outer diameter of the rolled thermal transfer receiving sheet is 60 to 230 mm.

15. The printing method for a thermal transfer receiving sheet according to claim 14, wherein the thermal transfer receiving sheet has an intermediate layer containing hollow particles and the image receiving layer sequentially provided on at least one side of a sheet-like support having cellulose pulp as its main component.

16. The printing method for a thermal transfer receiving sheet according to claim 7, wherein the thermal transfer receiving sheet has an intermediate layer containing hollow particles and the image receiving layer sequentially provided on at least one side of a sheet-like support having cellulose pulp as its main component.

17. The printing method for a thermal transfer receiving sheet according to claim 8, wherein the thermal transfer receiving sheet has an intermediate layer containing hollow particles and the image receiving layer sequentially provided on at least one side of a sheet-like support having cellulose pulp as its main component.

18. The printing method for a thermal transfer receiving sheet according to claim 9, wherein the thermal transfer receiving sheet has an intermediate layer containing hollow particles and the image receiving layer sequentially provided on at least one side of a sheet-like support having cellulose pulp as its main component.

19. The printing method for a thermal transfer receiving sheet according to claim 1, wherein the thermal transfer receiving sheet is provided with the image receiving layer on at least one side of a sheet-like support having a laminated structure consisting of at least three layers in which a thermoplastic resin film containing a porous structure is laminated on both sides of a core material layer.

20. The printing method for a thermal transfer receiving sheet according to claim 19, wherein the thermal shrinkage at 100° C. of the thermoplastic resin film on the side on which the image receiving layer is formed as determined according to JIS C2151 is 0.05 to 1.0%.
